(19) United States
(12) Patent Application Publication
(10) Pub. No.: US 2016/0137412 A1
(43) Pub. Date: May 19, 2016

(54) SEGREGATED RECEPTACLE

(71) Applicants: Johnny Capetillo, San Antonio, TX (US); Francisco Albiar, Alton, TX (US)

(72) Inventors: Johnny Capetillo, San Antonio, TX (US); Francisco Albiar, Alton, TX (US)

(21) Appl. No.: 14/542,579

(22) Filed: Nov. 15, 2014

(51) Int. Cl. B65F 1/08; B65F 1/16

(52) U.S. Cl. CPC B65F 1/085; B65F 1/16

(57) ABSTRACT

A segregated receptacle for collecting refuse and segregating the various types of refuse during storage. In this manner, collection, storage, and selective removal for recycling purposes is facilitated. A housing is defined by a cavity for receiving and containing the refuse. At least one collection tool for collection and organization of the refuse joins with an outer surface of the housing. An upper end of the housing includes a lid portion for regulating access to the reception opening. A lower end includes a trap door portion that selectively opens and closes to discharge the refuse from the housing. An interior portion forms a second container inside the housing that stores and segregates the refuse into a plurality of compartments. At least one barrier extends along the length of the interior portion for creating compartments therein. In this manner, the refuse can be segregated for recycling.

### CROSS-REFERENCE TO RELATED APPLICATIONS

The present Utility patent application claims priority benefit of the U.S. provisional application for patent Ser. No. 61/964,413 entitled “All Can”, filed on 2014-01-06, under 35 U.S.C. 119(e). The contents of this related provisional application are incorporated herein by reference for all purposes to the extent that such subject matter is not inconsistent herewith or limiting hereof].

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a segregated receptacle. More particularly, the invention relates to a segregated receptacle that includes attached tools for collecting eclectic types of refuse and a plurality of inner compartments for segregating the refuse.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a waste container is a container for temporarily storing waste, and is usually made out of metal or plastic. The general public deposits trash and recyclable material into these containers.

Typically, recycling is a process to change waste materials into new products to prevent waste of potentially useful materials, reduce the consumption of fresh raw materials, reduce energy usage, and reduce air and water pollution by reducing the need for conventional waste disposal. It is known that, a number of different systems have been implemented to collect recyclable materials from the general waste stream. These systems lie along the spectrum of trade-off between public convenience and government ease and expense. The three main categories of collection are drop-off centers, buy-back centers, and curbside collection.

Typically, once commingled recyclable materials are collected and delivered to a central collection facility, they must be sorted. This is done in a series of stages, many of which involve automated processes. Though sorting recyclable materials and separating it from trash is often expensive and time consuming.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a sectioned perspective view of an exemplary segregated receptacle, in accordance with an embodiment of the present invention;

FIG. 2 illustrates a top view of an exemplary interior portion with at least one barrier forming three compartments, in accordance with an embodiment of the present invention;

FIG. 3 illustrates a diagram of an exemplary interior portion moving into an exemplary housing, in accordance with an embodiment of the present invention; and

FIG. 4 illustrates a side view of an exemplary broom and an exemplary dustpan, where the dustpan receives the broom for storage, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of segregated receptacles that may be provided by preferred embodiments of the present invention. In one embodiment of the present invention, the segregated receptacle may include a receptacle for collecting refuse and segregating the various types of refuse during storage. The receptacle may also facilitate removal of the refuse. In this manner, collection, storage, and selective removal for recycling purposes is facilitated.

In some embodiments, the receptacle may include a housing defined by a cavity for receiving and containing the refuse. The refuse may include, without limitation, garbage, recyclable materials, food, animal waste, branches, and foliage. At least one collection tool for collection and organization of the refuse may join with an outer surface of the housing. Thus, the at least one collection tool may be configured to pick up, pile, and disperse different types of refuse. The at least one collection tool may be necessary because the refuse may include various forms, including, without limitation, solid objects, powder, liquid, and small refined granules.

In some embodiments, the housing may include an upper end and a lower end. The upper end may include a reception opening for receiving the refuse. A lid portion may regulate access to the reception opening. In some embodiments, the lower end may include a trap door portion that selectively opens and closes to discharge the refuse from the housing. In this manner, if a bag is not available to contain the refuse inside the cavity, the refuse can be removed from the trap door portion.

In some embodiments, the housing further comprises an interior portion configured to store and segregate the refuse into a plurality of compartments. The interior portion may include a container sized and dimensioned to position inside the cavity of the housing. At least one barrier may extend along the length of the interior portion for creating a plurality of compartments therein. Thus, in one embodiment, each type of refuse may be placed into a designated compartment for the respective refuse. Those skilled in the art will recognize that segregating the refuse may be useful for recycling purposes, since metals, plastics, and paper are recycled through different processes.

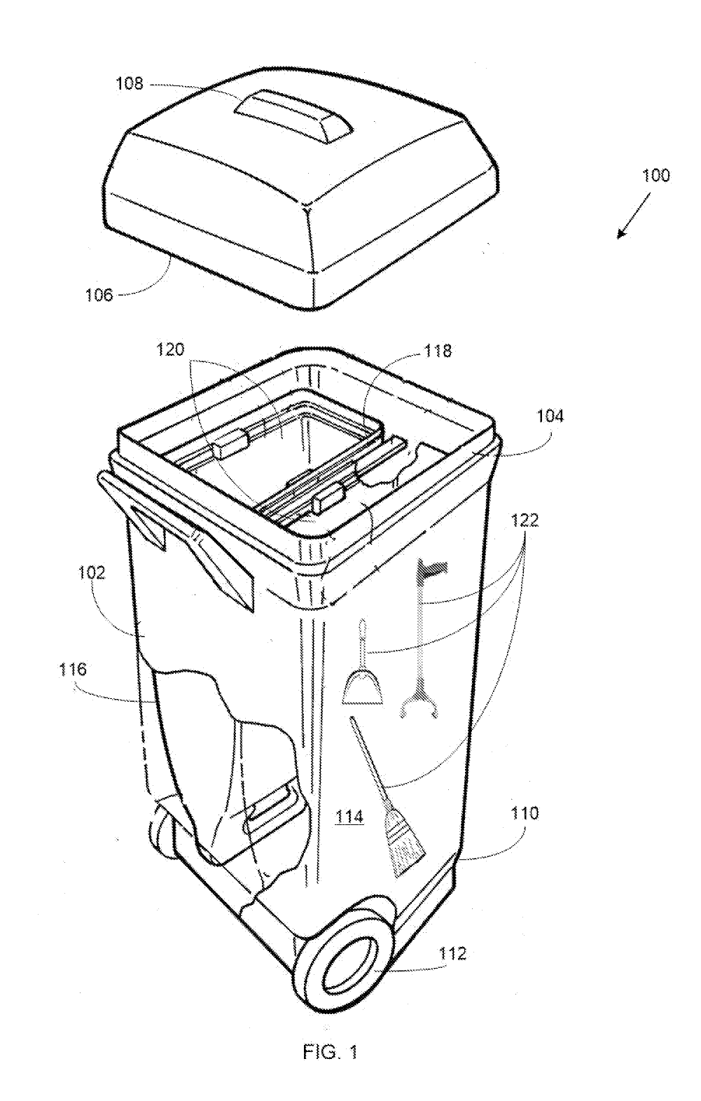

FIG. 1 illustrates a sectioned perspective view of an exemplary segregated receptacle, in accordance with an embodiment of the present invention. In the present invention, a segregated receptacle 100 may include a receptacle for collecting refuse and segregating the various types of refuse during storage. The receptacle may also facilitate removal of the refuse. The capacity to easily collect and segregate the refuse in the receptacle may facilitate recycling efforts. Those skilled in the art will recognize that there have been increasing efforts and a corresponding public awareness directed toward the reclamation and reuse of recyclable refuse and like materials, such as aluminum cans and containers, glass containers and other glass articles, and newspaper and similar paper products, which have traditionally been simply discarded. Each type of recyclable material is processed differently, and thus, must be separated from other recyclables or trash.

In some embodiments, the receptacle may include a housing 102 defined by a cavity for receiving and containing the refuse. The housing may include a generally cylindrical shape. However, any shape may be used, including, without limitation, a rectangle, a sphere, and a rhombus. The refuse may include, without limitation, garbage, recyclable materials, food, animal waste, branches, and foliage. Suitable materials for the housing may include, without limitation, recycled plastic, polypropylene, a rigid polymer, metal, and wood.

In some embodiments, at least one collection tool 122 for collection and organization of the refuse may join with an outer surface 114 of the housing. The collection tool may include, without limitation, a broom, a dustpan, a scissor pickup mechanism, a rake, a glove, and a bag. The tools may attach to the outer surface of the housing through a fastener, such as a hook. Thus, the at least one collection tool may be configured to pick up, pile, and disperse different types of refuse. The at least one collection tool may be necessary because the refuse may include various forms, including, without limitation, solid objects, powder, liquid, and small refined granules. For example, a broom may collect sand particles, a dustpan may pick up trash, and a scissor pickup mechanism may pick up aluminum cans.

In some embodiments, the housing may include an upper end 104 and a lower end 110. The upper end may include a reception opening for receiving the refuse. A lid portion 106 may regulate access to the reception opening. The lid portion may include a planar member sized and dimensioned to cover the reception opening. The lid portion may open and close by pivoting, sliding, or completely detaching from the reception opening. In one embodiment, the lid portion is effective for keeping animals out and odors in. A handle 108 on the lid portion may provide a grip for manipulating the lid portion. In some embodiments, the lower end may include a trap door portion that selectively opens and closes to discharge the refuse from the housing. The trap door portion may include a sliding door that selectively opens a portion of the lower end. In this manner, if a bag is not available to contain the refuse inside the cavity, the refuse can be removed from the trap door portion. The lower end of the housing may further comprises a mobility portion 112 for enabling movement of the segregated receptacle. The mobility portion may include a pair of wheels on an axle.

In some embodiments, the receptacle may further comprise an interior portion 116 disposed to position inside the cavity of the housing. The interior portion may be configured to store and segregate the refuse into a plurality of compartments. The interior portion may include a container sized and dimensioned to position inside the cavity of the housing. For example, if the housing is cylindrical, the interior portion is also cylindrical. The interior portion may form a snug fit with the housing, despite being detachable. The interior housing may include at least one barrier 118 that separates it into a plurality of compartments 120.

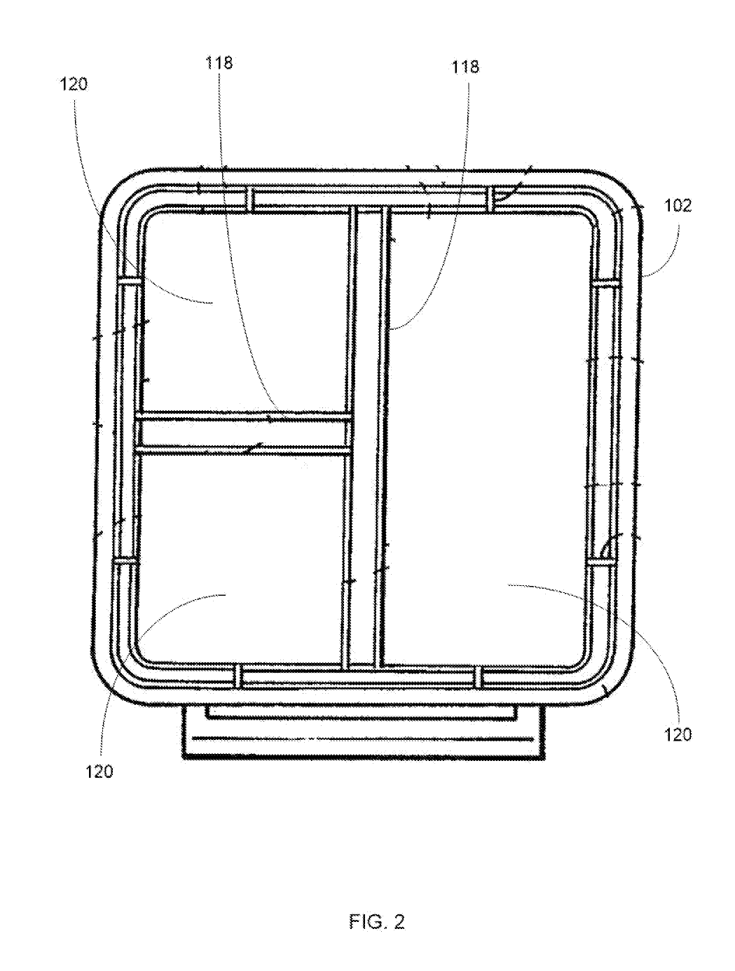

FIG. 2 illustrates a top view of an exemplary interior portion with at least one barrier forming three compartments, in accordance with an embodiment of the present invention. In the present invention, at least one barrier may extend along the length of the interior portion for creating a plurality of compartments therein. The barrier can form a cross shape, whereby four compartments are formed. However in other embodiments, any number of barriers may be used to create the desired compartments. Thus, in one embodiment, each type of refuse may be placed into a designated compartment for the respective refuse. The number of compartments can be altered by removing or adding the number of barriers in the interior portion. This provides flexibility in the amount and type of refuse collected.

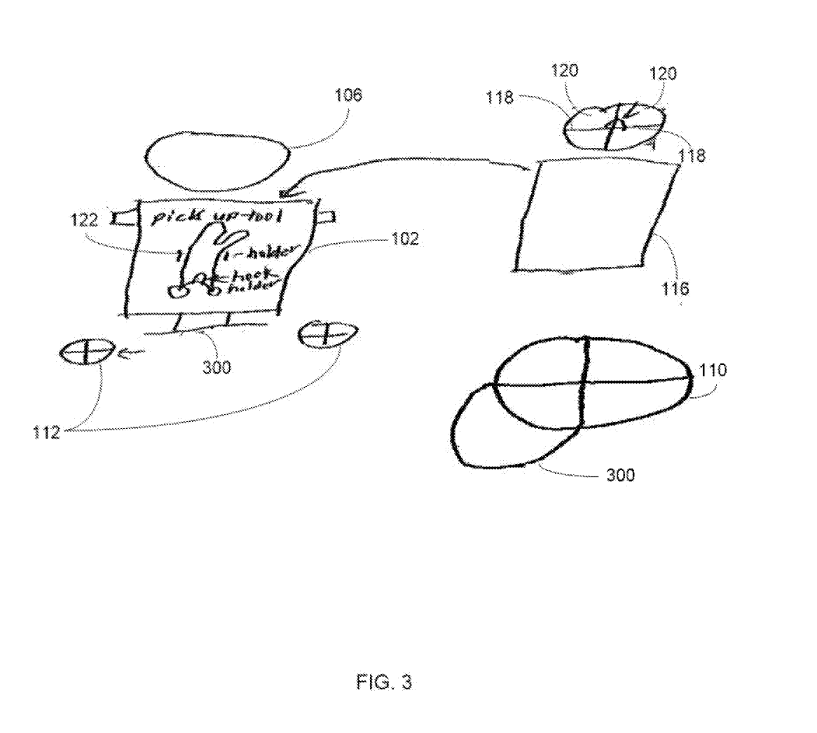

FIG. 3 illustrates a diagram of an exemplary interior portion moving into an exemplary housing, in accordance with an embodiment of the present invention. In the present invention, the interior portion positions in the cavity of the housing. However, in some embodiments, the housing may be used alone to store refuse. But the interior portion enables the segregation of the refuse. A bag may line the interior portion for removing the refuse. Those skilled in the art will recognize that segregating the refuse may be useful for recycling purposes, since metals, plastics, and paper are recycled through different processes. Thus, the compartments can be sized differently to accommodate different types of refuse. In one example, aluminum cans are placed in a large compartment, trash is placed in a mid-sized compartment, and paper is placed in a small compartment. In some embodiments, the interior portion may have a second trap door portion for selectively removing refuse from the interior portion. Thus, the housing and/or the interior portion may each have a trap door portion 300.

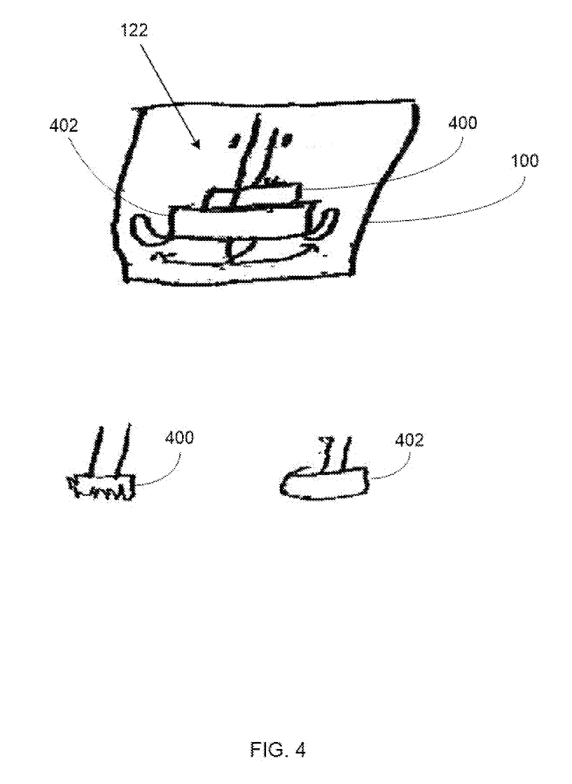

FIG. 4 illustrates a side view of an exemplary broom and an exemplary dustpan, where the dustpan receives the broom for storage. In the present invention, the tools used with the device may include a broom 400 and a dustpan. The broom and the dustpan attach to the outer surface of the device. Possible fasteners for retaining the tools to the outer surface may include, without limitation, a frictional snap, a magnet, a depression, a hook, and a slot. In one embodiment, the broom handle fits into the dustpan to conserve space.

In one alternative embodiment, the interior portion is configured to receive and store different types of liquids. In another alternative embodiment, the compartments are color coded to designate compartments for each type of refuse. In another alternative embodiment, lid portion is automated. In another alternative embodiment, the interior portion comprises a sensor to indicate when it is full. In another alternative embodiment, the mobility portion comprises sleds, rather than wheels.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a segregated receptacle collecting and receiving different types of refuse according to the present invention will be apparent to those skilled in the art. Various aspects of the invention have been described above by way of illustration, and the specific embodiments disclosed are not intended to limit the invention to the particular forms disclosed. The particular implementation of the segregated receptacle collecting and receiving different types of refuse may vary depending upon the particular context or application. By way of example, and not limitation, the segregated receptacle collecting and receiving different types of refuse described in the foregoing were principally directed to a receptacle having compartments for separating recyclable material from garbage, and tools for picking up the refuse and materials implementations; however, similar techniques may instead be applied to separating liquids into different compartments and having different pipes for receiving the liquids., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A receptacle comprising:
a housing defining a cavity, said housing comprising an outer surface, said outer surface arranged to join with at least one collection tool, said at least one collection tool configured to collect refuse, said housing further comprising an upper end and a lower end; and
an interior portion disposed to position at least partially inside said cavity, said interior portion comprising at least one barrier, said at least one barrier configured to segregate said interior portion into a plurality of compartments, each compartment configured to contain a portion of said refuse.

2. The receptacle of claim 1, in which said housing comprises a generally cylindrical shape.

3. The receptacle of claim 2, in which said refuse comprises trash, recyclable materials, food, foliage, and animal waste.

4. The receptacle of claim 3, in which said at least one collection tool comprises a broom.

5. The receptacle of claim 4, in which said at least one collection tool comprises a dustpan.

6. The receptacle of claim 5, in which said at least one collection tool comprises a scissor pickup mechanism.

7. The receptacle of claim 6, wherein said at least one tool is configured to join with said outer surface through a fastener.

8. The receptacle of claim 7, in which said upper end comprises a lid portion.

9. The receptacle of claim 8, wherein said lid portion is configured to regulate access to said cavity.

10. The receptacle of claim 9, in which said lid portion comprises a handle.

11. The receptacle of claim 10, in which said lower end comprises a trap door portion.

12. The receptacle of claim 11, wherein said trap door portion selectively opens and closes to at least partially discharge said refuse.

13. The receptacle of claim 12, in which said lower end comprises a mobile portion.

14. The receptacle of claim 13, in which said mobile portion comprises a pair of wheels resting on an axle.

15. The receptacle of claim 14, wherein said interior portion is configured to form a snug fit inside said cavity.

16. The receptacle of claim 15, in which said at least one barrier comprises four barriers extending from said upper end to said lower end of said housing.

17. The receptacle of claim 16, wherein a portion of said plurality of compartments are configured to contain recyclable material.

18. The receptacle of claim 17, wherein a portion of said plurality of compartments are configured to contain trash.

19. A receptacle comprising:
means for positioning a housing in proximity to refuse;
means for detaching at least one collection tool form an outer surface of said housing;
means for collecting refuse with said at least one collection tool;
means for removing a lid portion from an upper end of said housing;
means for segregating an interior portion with at least one barrier;
means for depositing a portion of said refuse into a designated compartment in said interior portion; and
means for removing at least a portion of said refuse from a trap door portion in a lower end of said housing.

20. A receptacle consisting of:
a housing defining a cavity, said housing comprising an outer surface, said outer surface arranged to join with at least one collection tool, said at least one collection tool comprising a broom, at least one collection tool comprising a dustpan, at least one collection tool comprises a scissor pickup mechanism, said at least one collection tool configured to collect refuse, said refuse comprising trash and recyclable material, said housing further comprising an upper end, said upper end comprising a lid portion configured to regulate access to said cavity, said housing further comprising a lower end, said lower end comprising a trap door portion configured to at least partially remove said refuse from said cavity; and
an interior portion disposed to position at least partially inside said cavity, said interior portion comprising at least one barrier, said at least one barrier configured to extend from said upper end to said lower end, said at least one barrier configured to segregate said interior portion into a plurality of compartments, each compartment configured to contain a portion of said refuse.
